(19) United States
(12) Patent Application Publication
(10) Pub. No.: US 2022/0134652 A1
(43) Pub. Date: May 5, 2022

(54) FILAMENT ADHESIVE DISPENSER SYSTEM

(71) Applicant: 3M INNOVATIVE PROPERTIES COMPANY, St. Paul, MN (US)

(72) Inventors: Mark E. NAPIERALA, St. Paul, MN (US); Thomas Q. CHASTEK, St. Paul, MN (US); Robert D. WAID, Maplewood, MN (US); Ilya A. Salnikov, Inver Grove Heights, MN (US); Petrus J. Bekker, Hastings, MN (US)

(21) Appl. No.: 17/432,006

(22) PCT Filed: Feb. 25, 2020
(86) PCT No.: PCT/IB2020/051605

§ 371 Date: Aug. 18, 2021

Related U.S. Application Data
(60) Provisional application No. 62/810,248, filed on Feb. 25, 2019.
(60) Provisional application No. 62/907,325, filed on Sep. 27, 2019.

(51) Int. Cl. B29C 64/209; B29C 64/314; B29C 64/321; B29C 64/295; B29C 64/118; B33Y 30/00; B33Y 40/10; B33Y 70/00

(52) U.S. Cl. CPC B29C 64/209; B29C 64/314; B29C 64/321; B29C 64/295; B29K 2105/0097; B33Y 30/00; B33Y 40/10; B33Y 70/00; B29C 64/118

(57) ABSTRACT

Provided are systems for dispensing a filament adhesive. The dispensing systems include a dispensing head with a barrel including one or more heating elements, and a rotatable screw received in the barrel, the rotatable screw including at least one mixing element. An inlet extends through a side of the barrel for receiving the filament adhesive. An outlet at a distal end of the barrel for dispensing the filament adhesive in molten form. The dispensing system further includes a filament adhesive having a configuration to be received into the inlet of the dispensing head. Using the provided dispensing systems, and optionally with the assistance of a computer, adhesives can be precisely applied to pre-determined locations on a substrate.

### FIELD OF THE INVENTION

Provided are dispenser systems for filament adhesives, along with components and methods thereof. The provided dispensers can be useful, for example, in applying a pressure-sensitive adhesive to a bonding surface.

### BACKGROUND

Pressure-sensitive adhesives are materials that adhere to a substrate upon application of pressure. They do not require solvent, water, or heat to provide an adhesive bond. State-of-the-art pressure-sensitive adhesives can achieve very high bond performance and are capable of replacing traditional mechanical fasteners in many industrial applications. These bonding solutions are also economical and easy to use.

Conventional pressure-sensitive adhesives are thin and flat, and generally dispensed in sheet or roll form. In certain applications, however, it can be advantageous for a pressure-sensitive adhesive to be formed in situ. In automotive bonding applications, for example, the bonding surfaces of a part can be non-planar to provide increased mechanical retention. Some parts can have a ribbed bonding surface that requires significant penetration of the pressure-sensitive adhesive into the ribbed structure to obtain adequate bond strength.

Moreover, the most common plastic used is thermoplastic olefin (“TPO”, sometimes referred to as “PP/EPDM”) which is a low surface energy plastic similar to polypropylene. Common pressure-sensitive adhesives do not achieve a high degree of “wet out” on these and similar plastics, resulting in reduced surface area between the adhesive and the substrate. Primers and other surface treatments can be used to improve “wet out,” but these add to the complexity and cost of bonding. For these reasons, bonding to non-planar low-surface-energy substrates remains a challenging technical problem.

### SUMMARY

Provided herein are systems, devices, kits and assemblies for mixing and dispensing filament adhesives. Filament adhesives include those that use a core/sheath configuration, including adhesives that are dispensed in hot melt form and then cooled to provide a pressure-sensitive adhesive. Using the provided dispensing devices, and optionally with the assistance of a computer, these adhesives can be precisely applied to pre-determined locations on a substrate. The ability to customize the size and shape of a pressure-sensitive adhesive provides improved versatility for manufacturers.

Core-sheath adhesives that have a pressure-sensitive adhesive core (i.e., core-sheath PSAs) are differentiated from conventional filaments in several ways. For one, pressure-sensitive adhesives tend to have a relatively soft viscoelastic consistency, which makes it challenging for many traditional FFF (fused filament fabrication) printheads. These materials tend to buckle and/or jam when pushed into a melt zone. Some FFF printheads have added feed tubes or guides that allows for feeding a rubber-based filament. These filaments can be successfully fed, however, primarily because they have Shore D durometers significantly higher than those of typical pressure-sensitive adhesive materials.

Another technical challenge relates to filament adhesive dimensions. To obtain an acceptable throughput for most industrial applications, the diameter of the provided filament needs to be sufficiently high, generally around six millimeters or more. This can be several times larger than the diameter of traditional filaments used in 3D printers. The larger diameter filament is desired to accommodate the material throughput required in a large-scale manufacturing process.

Core-sheath PSAs also behave differently from traditional hot melt adhesives. Unlike traditional hot melt materials, core-sheath PSAs retain a high melt viscosity when heated. This is desirable for dimensional stability of the dispensed adhesive on the substrate. Even when molten, these materials will not drip, sag or otherwise migrate from where they are disposed.

The present disclosure describes a dispensing system that is capable of dispensing filament adhesives such as core-sheath PSAs. Suitable substrates include, but are not limited to, irregular surfaces, complex geometries and flexible media. Additional uses of this pressure-sensitive adhesive include sealing, bonding in tight spaces, patterned adhesive placement, and consumer electronics bonding.

In a first aspect, a dispensing system is provided. The dispensing system comprises a dispensing head comprising: a barrel including one or more heating elements; an inlet extending through a side of the barrel for receiving the filament adhesive; an outlet at a distal end of the barrel for dispensing the filament adhesive in molten form; and a rotatable screw received in the barrel, the rotatable screw including at least one mixing element. The dispensing system further comprises a filament adhesive having a configuration to be received into the inlet of the dispensing head.

In a second aspect, the dispensing system further comprises a spool from which the filament adhesive can be continuously unwound while it is being received into the inlet of the dispensing head. Optionally, the spool can be coupled to the dispensing head.

In a third aspect, the dispensing system further comprises a movable arm, where the dispensing head is coupled to a distal end of the movable arm.

In a fourth aspect, the dispensing head of the dispensing system is coupled to a table, where movement of either the dispensing head or table is controllable by a computer.

### BRIEF DESCRIPTION OF THE DRAWINGS

FIG. 1 is a perspective view of a filament adhesive; FIG. 2 is a side cross-sectional view of a dispensing head for dispensing the filament adhesive of FIG. 1 according to one exemplary embodiment; FIG. 3 is a side elevational of a barrel component of the dispensing head of FIG. 2, revealing certain internal surfaces in dotted lines;

FIG. 4 is a side elevational view of a screw component of the dispensing head of FIG. 2;

FIG. 5 is a front cross-sectional view of the component of FIG. 4; and

FIG. 6 is perspective view of a system that incorporates the filament adhesive of FIG. 1 and dispensing head of FIGS. 2-3, respectively.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DEFINITIONS

As used herein:

“Ambient conditions” means at a temperature of 25 degrees Celsius and a pressure of 1 atmosphere (approximately 100 kilopascals).

“Ambient temperature” means at a temperature of 25 degrees Celsius.

“Nominal screw length” refers to the length of the flighted portion of an extrusion screw (the portion that normally comes into contact with the extrudate).

“Non-tacky” refers to a material that passes a “Self-Adhesion Test”, in which the force required to peel the material apart from itself is at or less than a predetermined maximum threshold amount, without fracturing the material. The Self-Adhesion Test is described below and is typically performed on a sample of the sheath material to determine whether or not the sheath is non-tacky.

“Pressure-sensitive adhesives” refers to materials that are normally tacky at room temperature and can be adhered to a surface by application of light finger pressure and thus may be distinguished from other types of adhesives that are not pressure-sensitive. A general description of pressure-sensitive adhesives may be found in the Encyclopedia of Polymer Science and Engineering, Vol. 13, Wiley-Interscience Publishers (New York, 1988). Additional description of pressure-sensitive adhesives may be found in the Encyclopedia of Polymer Science and Technology, Vol. 1, Interscience Publishers (New York, 1964). “Pressure sensitive adhesive” or “PSA”, as used herein, refers to a viscoelastic material that possesses the following properties: (1) aggressive and permanent tack, (2) adherence to a substrate other than a fluorothermoplastic film with no more than finger pressure, and (3) sufficient cohesive strength to cleanly release from the substrate. A pressure-sensitive adhesive may also meet the Dahlquist criterion described in Handbook of Pressure-Sensitive Adhesive Technology, D. Satas, 2^{nd} ed., page 172 (1989). This criterion defines a pressure-sensitive adhesive as one having a one-second creep compliance of greater than 1×10⁻⁶ cm²/dyne at its use temperature (for example, at temperatures in a range of from 15° C. to 35° C.).

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements. It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described relating to the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

Assemblies and methods described herein are useful in dispensing adhesives, in molten form, onto a substrate. The dispensed adhesives are optionally pressure-sensitive adhesives. In some embodiments, the dispensed adhesives have a composition that renders unnecessary the prior application of a primer on the substrate. The elimination of a priming step saves time and costs, and is of great convenience to the user.

Advantageously, the provided assemblies and methods can use filament adhesives. Filament adhesives are adhesives provided in a continuous thread-like configuration. The filament adhesive preferably has a uniform cross-section. Advantageously, a filament adhesive can be fed continuously from a spool into a dispensing apparatus, such as a dispensing head.

Particularly useful filament adhesives have a core-sheath filament configuration, as described in co-pending U.S. Provisional Patent Application No. 62/633,140 (Nyaribo, et al.). Core-sheath filament materials have a configuration in which a first material (i.e., the core) is surrounded by a second material (i.e., the sheath). Preferably, the core and the sheath are concentric, sharing a common longitudinal axis. The ends of the core need not be surrounded by the sheath.

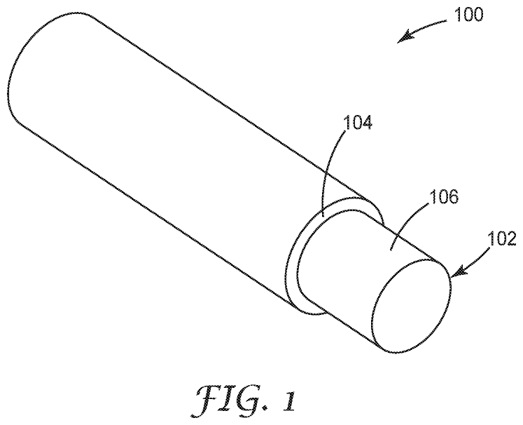

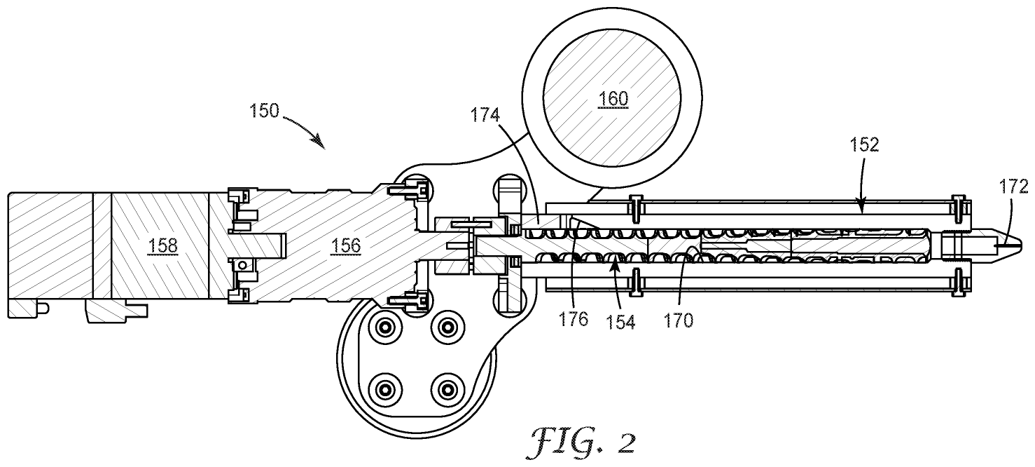

An exemplary filament adhesive is shown in FIG. 1 and hereinafter referred to by the numeral 100. The core-sheath filament adhesive 100 comprises an adhesive core 102 and a non-tacky sheath 104. The adhesive core 102 is a pressure-sensitive adhesive at ambient temperature. As shown, the core 102 has a cylindrical outer surface 106 and the sheath 104 extends around the outer surface 106 of the core 102. The core-sheath filament adhesive 100 has a cross-section that is generally circular as shown here, but it is to be understood that other cross-sectional shapes (e.g., square, hexagonal, or multi-lobed shapes) are also possible.

Advantageously, the non-tacky sheath 104 prevents the filament adhesive 100 from sticking to itself, thereby enabling convenient storage and handling of the filament adhesive 100 on a spool.

The diameter of the core-sheath filament is not particularly restricted. Factors that influence the choice of filament diameter include the size constraints on the adhesive dispenser, desired adhesive throughput, and precision requirements for the adhesive application. The core-sheath filament can comprise an average diameter of 1 millimeter to 20 millimeters, 3 millimeters to 13 millimeters, 6 millimeters to 12 millimeters, or in some embodiments, less than, equal to, or greater than 1 millimeter, 2, 3, 4, 5, 6, 7, 8, 9, 10, 11, 12, 13, 14, 15, 16, 17, 18, 19, or 20 millimeters. The filament adhesive 100 can be a stock item and provided in any length appropriate for the application.

The dispensing methods described herein offer many potential technical advantages, at least some of which are unexpected. These technical advantages include: retention of adhesive properties after dispensing, low volatile organic compound (VOC) characteristics, avoiding die cutting, design flexibility, achieving intricate non-planar bonding patterns, printing on thin and/or delicate substrates, and printing on irregular and/or complex topologies.

Core sheath filament adhesives according to the present disclosure can be made using any known method. In an exemplary embodiment, these filament adhesives are made by extruding molten polymers through a coaxial die. Technical details, options and advantages concerning the aforementioned core sheath filament adhesives are described in U.S. Provisional Patent Application No. 62/633,140 (Nyaribo, et al.).

FIG. 2 shows a dispensing head 150 having a configuration for receiving, melting, mixing, and dispensing the filament adhesive 100 of FIG. 1. The dispensing head 150 includes a barrel 152 and a rotatable screw 154 received therein. A gearbox 156 and motor 158 are operatively coupled to the screw 154, and an alignment wheel 160, which may be motorized, is affixed to a side of the barrel 152 through which filament is guided into the dispensing head 150. Further details concerning each of these components are below.

The barrel 152 has the configuration of a barrel used in a single screw extruder. The barrel 152 has an inner surface 170 that is cylindrical and engages the screw 154 in an encircling relation. The inner surface 170 terminates in an outlet 172 at a distal end of the barrel 152. The outlet 172 is generally circular but could also be rectangular or have any other suitable shape. The barrel 152 includes one or more embedded heating elements (not visible) for heating the inner surface 170 and melting the filament adhesive during a dispensing operation. Optionally, the inner surface 170 of the barrel 152 can be grooved or otherwise textured to increase friction between the barrel 152 and the extruded adhesive.

Referring again to FIG. 2, an inlet 174 extends through the top side of the barrel for receiving the filament adhesive. As further shown, the inlet 174 includes a front sidewall 176 defining a beveled nip point where the front sidewall 176 converges with the outer surface of the screw 154. Advantageously, the beveled nip point prevents breakage of the filament adhesive as it is drawn into the barrel 152. The beveled nip point is part of a robust feeding mechanism enabling the filament adhesive to be continuously fed into the barrel 152 without need for operator attendance.

The drive mechanism for the dispensing head 150 is provided by the gearbox 156 and motor 158. In some embodiments, the dispensing head 150 includes controls allowing for adjustment of the speed and/or torque of the rotatable screw 154. In some embodiments, the motor 158 is a servo motor. Servo motors are advantageous because they can provide a high degree of torque over a wide range of rotational speed.

As shown, the inlet 174 generally has the shape of a reverse funnel, in which the transverse cross-sectional area of the inlet 174 increases with increasing proximity to the screw 154. The inlet 174 has one or more sidewalls, such as front sidewall 176 as shown. The front sidewall 176 can be planar or curved. As viewed from a transverse direction, at least a portion of the front sidewall 176 extends at an acute angle relative to a longitudinal axis of the screw 154. The acute angle, which facilitates feeding of the filament adhesive, can be from 10 degrees to 70 degrees, from 18 degrees to 43 degrees, from 23 degrees to 33 degrees, or in some embodiments, less than, equal to, or greater than 10 degrees, 13, 15, 17, 20, 22, 25, 27, 30, 32, 35, 37, 40, 42, 45, 47, 50, 53, 55, 57, 60, 65, or 70 degrees.

FIG. 3 shows a top view of the barrel 152, revealing further detail concerning the shape of the inlet 174. The inlet 174 includes outer entrance 175 and hidden surfaces extending from the outer entrance 175 and shown in dotted lines. As can be seen from FIG. 3, the front sidewall 176 is not planar, but has a complex compound curvature. Curved surfaces of the inlet 174, which include the front sidewall 176, collectively define a recess in the inner surface 170 of the barrel 152 to accommodate the filament adhesive as it is being fed. Overall, the inlet 174 can extend along from 10 percent to 40 percent, from 15 percent to 35 percent, 20 percent to 30 percent, or in some embodiment, less than, equal to, or greater than 10 percent, 12, 15, 17, 20, 22, 25, 27, 30, 32, 35, 37, or 40 percent of the nominal screw length.

The recess circumscribed by the inlet 174 can extend, as here, along both axial and circumferential directions relative to the screw 154. By providing space for the filament adhesive to move within the barrel 152, the recess reduces the likelihood that the flights of the rotatable screw 154 would sever the filament adhesive during operation of the dispensing head 150. This is inconvenient because filament breakage interrupts the dispensing process and requires that an operator manually re-inserts the filament adhesive into the dispensing head 150 before re-starting the process.

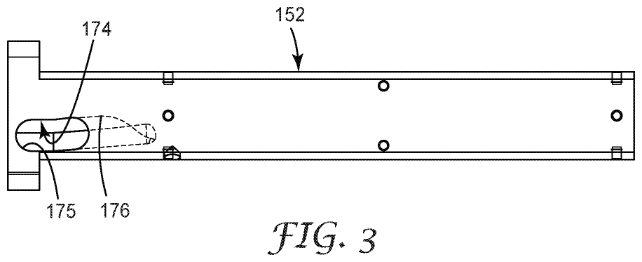

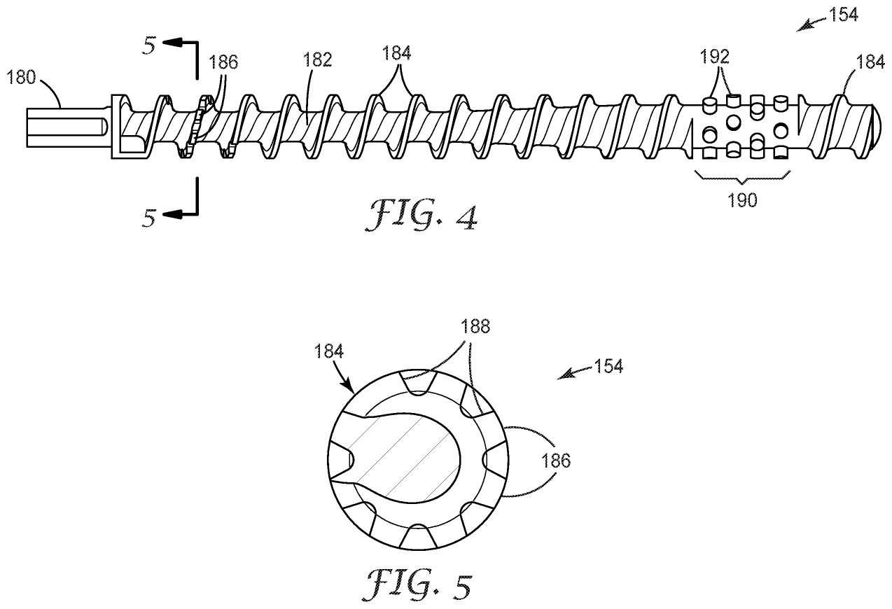

FIGS. 4 and 5 show features of the screw 154 in more detail. The screw 154 includes a shank 180 at one end for coupling to a drive mechanism. The shank 180 is connected to a shaft 182 with a diameter that progressively increases along its length. Extending around the shaft 182 are helical flights 184 for conveying molten material in the forward direction as the screw 154 rotates within the barrel 152.

Proximate to where the filament adhesive is fed into the dispensing head 150, notches 188 are provided in the helical flights 184 to provide gripping lugs 186, as also shown in the cross-sectional view of FIG. 5. The gripping lugs 186 provide additional edges that assist in catching and actively pulling a continuous filament adhesive through the inlet 174 and into the barrel 152. This is a significant benefit over feeding mechanisms that require adhesive to be pushed into the feed zone, which can induce buckling and kinking of the filament adhesive. The gripping lugs 186 can extend across from 1 percent to 30 percent, from 3 percent to 25 percent, from 5 percent to 20 percent, or in some embodiments, less than, equal to, or greater than 1 percent, 2, 3, 4, 5, 6, 7, 8, 9, 10, 11, 12, 13, 14, 15, 16, 17, 18, 19, 20, 22, 25, 27, or 30 percent of the nominal screw length.

Located on the opposite end of the screw 154 is a mixing section 190. The mixing section 190 includes a plurality of cylindrical posts 192. The mixing section 190 may be represented in other configurations not shown in FIG. 4, however. Other screw features that may be employed include fluted cylinders (as found in Maddock mixers), densely flighted screw sections with crosscuts (as found in Saxton mixers), or any of a variety of known post patterns, including those used for pineapple mixers. Optionally, posts or pins may be disposed on the interior sidewalls of the barrel 152 and aid in the mixing process; if so, crosscuts may be present in the flights of the screw 154 to avoid interference.

The length of the mixing section 190 is not particularly restricted and can depend on various factors including the adhesive composition being extruded and the feed rate of the filament adhesive. The mixing section 190 can be from 5 percent to 30 percent, from 7 percent to 25 percent, from 8 percent to 20 percent, or in some embodiments, less than, equal to, or greater than 5 percent, 6, 7, 8, 9, 10, 11, 12, 13, 14, 15, 16, 17, 18, 19, 20, 22, 25, 27, 30, or 35 percent of the nominal screw length.

For effective melting, mixing, and dispensing of a filament adhesive within a relatively compact enclosure, the ratio of nominal screw length and screw diameter can be from 8:1 to 20:1, from 9:1 to 17:1, from 10:1 to 14:1, or in some embodiments, less than, equal to, or greater than 8:1, 9:1, 10:1, 11:1, 12:1, 13:1, 14:1, 15:1, 16:1, 17:1, 18:1, 19:1, or 20:1.

The provided dispensing head 150 can display significant throughputs. In preferred embodiments, the dispensing head is capable of dispensing the adhesive composition at a throughput of at least 3 kg/hr, at least 4 kg/hr, at least 5 kg/hr, at least 6 kg/hr, at least 7 kg/hr, or at least 8 kg/hr.

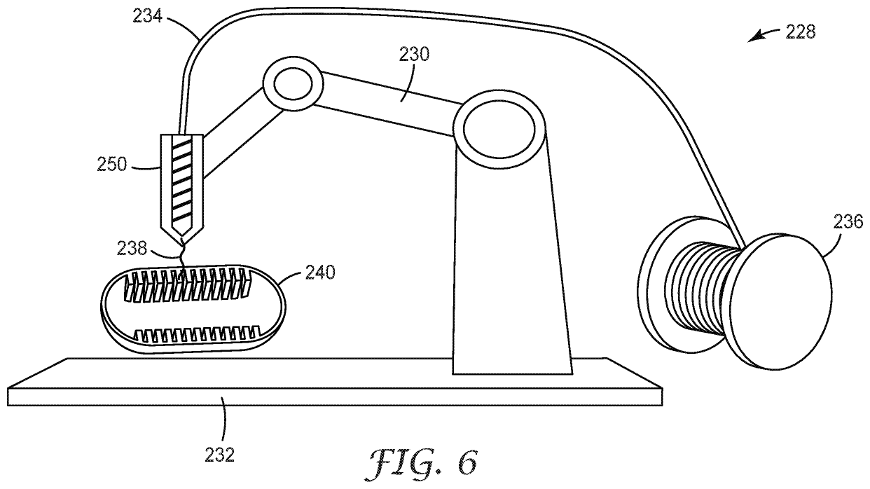

FIG. 6 presents a schematic illustration of a dispensing system 228 that includes a dispensing head 250 outfitted with a mount for attachment to the end of a movable arm 230.

The dispensing head 250 can have features analogous to that of the dispensing head 150 as previously described. The movable arm 230 is affixed to a table 232 and can have any number of joints to allow the dispensing head 250 to be translated and rotated in up to six degrees of freedom. The movable arm 230 allows the dispensing head 250 to dispense an adhesive composition with precision and reproducibility, and over a wide range of locations relative to the table 232.

Optionally and as shown, the dispensing system 228 additionally includes a filament adhesive 234 for continuously feeding into the dispensing head 250 as shown in FIG. 6. The filament adhesive 234 can be continuously unwound from a spool 236 as shown. It is to be understood that the location of the spool 236 relative to other components of the dispensing system 228 is not critical and can mounted where convenient. The spool 236 can be fixtured to the table 232 or a structure thereon.

The dispensing head 250 of FIG. 6 is being shown dispensing an adhesive composition 238 in hot melt form onto the bonding surface of a substrate 240. The substrate 240 need not be limited and can be, for example, an industrial part to be adhesively coupled to an assembly. As an option, the substrate 240 can be mounted onto the table 232, thereby providing a spatial point of reference for positioning of the dispensing head 250. This can be especially useful in an automatic process, where a computer is used to control the position and orientation of the dispensing head 250.

The dispensing of the adhesive composition 238 can be automated or semi-automated, thus requiring little or no intervention by a human operator. One advantage of the provided methods is the possibility of dispensing the adhesive composition 238 onto the substrate 240 according to instructions provided by a computer and based on a pre-determined pattern. The pre-determined pattern can be 2-dimensional (along a planar surface) or 3-dimensional (along a non-planar surface). The pre-determined pattern can be represented by digitized model on the computer, enabling the pre-determined pattern to be customized for any of a variety of different substrates.

Here, the adhesive composition 238 is a thermoplastic elastomer, allowing it to continue to flow after it is dispensed. In certain applications, the molten adhesive conforms to the shape of protruding or recessed features of the substrate 240 for increased mechanical retention. Optionally, the protruding or recessed features can have one or more undercuts to further improve the strength of the bond.

In FIG. 6, the bonding surface of the substrate 240 has a ribbed configuration, enabling the adhesive composition 238 to flow and penetrate into the recessed areas between the ribs. By providing an increased surface area for bonding, this configuration provides a significantly stronger bond compared with a planar bond configuration. Upon cooling the adhesive composition 238 to ambient temperature, its cohesive strength increases, and the material behaves as a pressure-sensitive adhesive.

In some embodiments, the adhesive-backed substrate 240 can be immediately placed in contact with a corresponding article or assembly to close the bond. Such an operation may be manual, semi-automated, or fully automated. If the adhesive-backed substrate 240 is not ready to be bonded, exposed surfaces of the dispensed adhesive can be covered by a release liner to preserve its tackiness. Depending on the application, the adhesive-backed substrate can then be packaged, stored, or transported to a subsequent manufacturing process.

Further refinements are also possible. While not explicitly shown in the drawings, one or more additional heating elements may be provided to pre-heat the filament adhesive before it enters the heated barrel of the dispensing head. Pre-heating the filament adhesive can allow the screw/barrel to be shortened, since less heat is needed to melt a pre-heated adhesive. The additional heating elements can be located on a peripheral component or part of the dispensing head itself. In some embodiments, the alignment wheel 160 incorporates the additional heating elements.

The dispensed adhesive can also be applied to another adhesive article. For example, it can be used to make a skin adhesive on a foam tape. The dispensed material may be foamed or non-foamed. Non-foamed adhesive compositions are sometimes preferred because they are more easily reworked without loss in performance. Foamed adhesives, on the other hand, can be cost-effective and useful for bonding to rough, or otherwise uneven, surfaces. Optionally, the filament adhesive is foamed by incorporating glass bubbles or other foaming ingredients into the filament adhesive composition.

Useful features and applications for the provided dispensing head can extend beyond those in this disclosure, and some are described in co-pending U.S. Provisional Patent Application No. 62/810,221 (Napierala et al.) and 62/810,248 (Napierala et al.), both filed on Feb. 25, 2019.

There are many advantages to dispensing a pressure-sensitive adhesive using the provided dispensing head. Its deployment in a dispensing system uses a spooled filament adhesive as a roll good, making loading and replacement of consumable materials easier, particularly in an automated process. The provided screw configurations are also well suited for use PSA filament adhesives, which have a relatively soft viscoelastic consistency and are difficult to feed into conventional dispensers. Unlike conventional dispensers, the provided dispensing head does not need guide structures for feeding the filament adhesive.

The provided dispensing head is also modular, enabling it to be used with any of various customized nozzles, providing a desired degree of precision in adhesive placement. The provided dispensing head can allow adhesive to be dispensed in a customized fashion. For example, it is possible to dispense an adhesive onto a substrate in a dot, stripe, or other discontinuous, pattern. Suitable coating patterns, as mentioned previously, need not be planar and can located on complex and irregular bonding surfaces.

The provided dispensing head is highly efficient and lightweight. In some embodiments, the dispensing head has an overall weight that is at most 10 kg, at most 8 kg, or at most 6 kg. Working examples of the dispensing head are light and compact enough to be mounted to light duty robotic arms currently used in manufacturing facilities. Since the screw and barrel are configured to provide excellent mixing within a short residence time in the melt zone, there is also reduced waste and minimal risk of thermal degradation of the adhesive.

While not intended to be exhaustive, further embodiments of the provided dispensing systems are provided below:
1. A dispensing system comprising: a dispensing head comprising: a barrel including one or more heating elements; an inlet extending through a side of the barrel for receiving the filament adhesive; an outlet at a distal end of the barrel for dispensing the filament adhesive in molten form; and a rotatable screw received in the barrel, the rotatable screw including at least one mixing element; and a filament adhesive having a configuration to be received into the inlet of the dispensing head.
2. The dispensing system of embodiment 1, wherein the at least one mixing element comprises a plurality of posts disposed on a rotatable shaft.
3. The dispensing system of embodiment 1 or 2, wherein the filament adhesive comprises a core-sheath adhesive.
4. A dispensing system comprising: a dispensing head comprising: a barrel including one or more heating elements; an inlet extending through a side of the barrel for receiving the filament adhesive; an outlet at a distal end of the barrel for dispensing the filament adhesive in molten form; and a rotatable screw received in the barrel; and a filament adhesive having a configuration to be received into the inlet of the dispensing head, wherein the filament adhesive comprises a core-sheath adhesive.
5. The dispensing system of embodiment 3 or 4, wherein the core-sheath adhesive comprises a pressure-sensitive adhesive core that is viscoelastic at ambient temperature.
6. The dispensing system of any one of embodiments 3-5, wherein the core-sheath adhesive comprises a sheath that is non-tacky at ambient temperature.
7. The dispensing system of any one of embodiments 1-6, wherein the inlet comprises a beveled nip point defined in part by a front sidewall surface of the inlet that extends at an acute angle relative to a longitudinal axis of the rotatable screw.
8. The dispensing system of embodiment 7, wherein the acute angle is from 13 degrees to 53 degrees.
9. The dispensing system of any one of embodiments 1-8, wherein the inlet extends along 10 percent to 40 percent of the nominal screw length of the rotatable screw.
10. The dispensing system of any one of embodiments 1-9, wherein the rotatable screw further comprises a feed element adjacent to the inlet, the feed element comprising a plurality of gripping lugs.
11. The dispensing system of any one of embodiments 1-10, wherein the rotatable screw has a length:diameter ratio of from 8:1 to 20:1.
12. The dispensing system of any one of embodiments 1-11, further comprising a drive mechanism operatively coupled to the rotatable screw.
13. The dispensing system of any one of embodiments 1-12, wherein the overall weight of the dispensing head is no more than 10 kg.
14. The dispensing system of any one of embodiments 1-13, further comprising a spool from which the filament adhesive can be continuously unwound while it is being received into the inlet of the dispensing head.
15. The dispensing system of embodiment 14, wherein the spool is coupled to the dispensing head.
16. The dispensing system of any one of embodiments 1-15, further comprising a movable arm, wherein the dispensing head is coupled to a distal end of the movable arm.
17. The dispensing system of any one of embodiments 1-16, wherein the dispensing head is coupled to a table, and wherein either the dispensing head or the table is movable relative to the other.
18. The dispensing system of embodiment 17, further comprising a movable arm coupled to the table, wherein the dispensing head is coupled to a distal end of the movable arm.
19. The dispensing system of embodiment 17 or 18, wherein movement of the dispensing head or the table is controllable by a computer.
20. The dispensing system of any one of embodiments 17-19, further comprising a spool from which the filament adhesive can be continuously unwound while it is being received into the inlet of the dispensing head, wherein the spool is mounted to the table or structure thereon.

### EXAMPLES

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

TABLE 1
Materials:

| Designation | Description | Source |
|---|---|---|
| AA | Acrylic acid | BASF Corporation, |
| | | Florham Park, NJ. |
| | | United States |
| EHA | 2-ethyl hexyl acrylate | BASF Corporation, |
| | | Florham Park, NJ. |
| | | United States |
| IOTG | Isooctylthioglycolate | Showa Denko |
| | | Corporation Tokyo, |
| | | Japan |
| Irg651 | 2-dimethoxy-2-phenylaceto- | BASF Corporation, |
| | phenone, a photoinitiator | Florham Park, NJ. |
| | available under the trade | United States |
| | designation IRGACURE 651 | |
| Nucrel | Ethylene-acrylic acid copolymer | Dupont Chemical, |
| | resin 9 wt % Acrylic Acid with a | Wilmington, Delaware, |
| | melt flow index of 10 gram/10 | United States |
| | min, available under the trade | |
| | designation NUCREL 3990 | |

### Test Methods

90° Peel Strength Test: A 12.5-millimeter wide by 1.5-millimeter thick by 125-millimeter long strip of sample adhesive was dispensed directly onto a substrate. The sample adhesive was allowed to cool to room temperature (25° C.) for ten minutes. Next, aluminum foil was manually laminated to the exposed sample adhesive surface using two passes of a 6.8-kilogram steel roller in each direction. The bonded samples were allowed to dwell for four hours at 25° C. and 50% humidity. The peel test was carried out using a tensile tester equipped with a 50-kilonewton load cell at room temperature with a separation rate of 30.5 centimeters/minute. The average peel force was recorded and used to calculate the average peel adhesion strength in newtons/centimeter.

Static Shear Strength Test: A 12.5-millimeter wide by 1.5-millimeter thick by 25.4-millimeter long strip of sample adhesive was dispensed directly onto an aluminum coupon with the length of the strip spanning the width of an aluminum coupon. The aluminum coupon was created by cutting an aluminum plaque material (anodized aluminum 5005-H34 Code 990MX, 1.6-mm thick, 101.6-mm wide, 304.8-mm long obtained from Lawrence & Frederick Inc, Streamwood, Ill., United States) into 25.4-millimeter wide by 50-millimeter long pieces with a six-millimeter hole centered on the narrow edge for hanging a bonded sample onto a test hook. After cooling to room temperature for ten minutes, a 25.4-millimeter wide by 120-millimeter long aluminum foil strip was attached to the exposed sample adhesive surface using two manual passes of a 6.8-kilogram steel roller in each direction. The tail of the foil was looped over and stapled. The bonded samples were subjected to a dwell time of four hours at 25° C. and 50% humidity. The test panel was mounted vertically onto a hook at room temperature, and a 250-gram weight was attached to the loop in the aluminum foil. The hanging time at which the sample fell from the plastic substrate was recorded. The test was stopped after 72 hours if failure had not occurred.

Self-Adhesion Test: It is desirable for the core-sheath filaments to not fuse or block together during storage. The sheath material provides the non-adhering surface to cover the core adhesive. The Self-Adhesion Test was conducted on films of the pure sheath material to determine whether or not candidate sheath materials would meet the requirement of being “non-tacky”. Coupons (25 millimeters×75 millimeters×0.8 millimeters) were cut out. For each material, two coupons were stacked on each other and placed on a flat surface within an oven. A 750-gram weight (43-millimeter diameter, flat bottom) was placed on top of the two coupons, with the weight centered over the films. The oven was heated to 50 degrees Celsius, and the samples were left at that condition for 4 hours, and then cooled to room temperature. A static T-peel test was used to evaluate pass/fail. The end of one coupon was fixed to an immobile frame, and a 250-g weight was attached to the corresponding end of the other coupon. If the films were flexible and began to peel apart, they formed a T-shape. If the two coupons could be separated with the static 250-gram load within 3 minutes of applying the weight to the second coupon, it was considered a pass and was non-tacky. Otherwise, if the two coupons remained adhered, it was considered a fail.

### Example 1 (EX1)

### Step 1: Acrylic Resin Preparation

Two sheets of ethylene/vinyl acetate film having a vinyl acetate content of 6% and a thickness of 0.0635 millimeters (0.0025 inches) (obtained from Consolidated Thermoplastics Co. of Schaumburg, Ill. United States) were heat sealed on their lateral edges and the bottom using a liquid form, fill, and seal machine to form a rectangular tube measuring 5 cm (1.97 inches) wide. The tube was then filled with a monomer mixture of 89.8% EHA, 10% AA, 0.05% IOTG, and 0.15% Irg651. The filled tube was then heat sealed at the top and at periodic intervals along the length of the tube in the cross direction to form individual pouches measuring 18 cm by 5 cm, each containing 26 grams of composition. The pouches were placed in a water bath that was maintained between about 21° C. and 32° C., and exposed first on one side then on the opposite side to ultraviolet radiation at an intensity of about 4.5 milliwatts/square centimeter for 8.3 minutes to cure the composition. The radiation was supplied from lamps having about 90% of the emissions between 300 and 400 nanometers (nm).

### Step 2: Creation of Sample Adhesive Composition

The Acrylic Resin (created in Step 1) and Nucrel were coaxially coextruded to form a core-sheath filament. Nucrel was the outer sheath material and was 6.5% of the overall adhesive composition by mass. The filament diameter was 8 millimeters. The Acrylic Resin was fed into the coaxial die at 163 degrees Celsius, through a 40-millimeter twin screw rotating at 200 RPM. The Nucrel was fed into the die at 193 degrees Celsius from a 19-millimeter twin screw rotating at 9 RPM. The filament adhesive was wound onto rolls and stored for dispensing. Nucrel was subjected to Self-Adhesion testing and passed.

### Step 3: Dispense Sample Adhesive

The dispensing temperature was 180 degrees Celsius. The screw speed for test samples was 300 RPM for making test specimens, and varied for throughput measurements, as represented in Table 3.

TABLE 2
Throughput Measurements at Various Screw RPM

| Screw | Flow Rate |
|---|---|
| RPM | (kg/h) |
| 30 | 1.3 |
| 100 | 4.3 |
| 200 | 7.2 |
| 250 | 8.6 |

Throughput of the dispenser was measured by collecting material for 60 seconds, and weighing the dispensed material.

In addition to throughput measurements, adhesive bond performance was evaluated using adhesive EX1. Substrates were coated by manually moving them under the dispense head at 25 millimeters per second. The gap between the substrate and the nozzle was one millimeter during dispensing. Aluminum (anodized aluminum 5005-H34 Code 990MX, 1.6-mm thick, 101.6-mm wide, 304.8-mm long obtained from Lawrence & Frederick Inc, Streamwood, Ill., United States) and wood (S4S Poplar 12.7-thick, 76.2-mm wide, 300-mm long) substrates were peel strength tested as received without any additional cleaning or priming steps. Bonded test specimens were then evaluated for 90° Peel Strength and Static Shear Strength. The results are represented in Table 3.

### Comparative Example 1 (CE1)

An acrylic foam tape with a comparable composition was selected for comparison to the EX1. Aluminum and wood were selected as substrates to represent substrates that are both recommended and not recommended for acrylic foam tape. The porous irregular wood substrate is generally not recommended for acrylic foam tape bonding because of limited bond performance. Acrylic foam tape, 5665 obtained from 3M Company of St. Paul, Minn., United States, was cut to the sizes described below and underwent 90° Peel Strength and Static Shear Strength testing as mentioned above. With slight modification to the test methods respecting preparation of the samples defined as follows: A 12.5-millimeters wide by 125-millimeters long strip was adhered to an aluminum foil strip, with the non-liner side attaching to the aluminum strip. The release liner was removed and the liner side was attached to the substrate of interest using two manual passes of a 6.8-kilogram steel roller in each direction. Aluminum (anodized aluminum 5005-H34 Code 990MX, 1.6 mm thick, 101.6 mm wide, 304.8 mm long obtained from Lawrence & Frederick Inc, Streamwood, Illinois, United States) and wood (S4S Poplar 12.7 thick, 76.2 mm wide, 300 mm long) substrates were peel strength tested as received without any additional cleaning or priming steps. The results are represented in Table 3.

TABLE 3
Peel Adhesion and Shear Strength

| | Peel Strength to | Peel Strength to | |
|---|---|---|---|
| | Aluminum | Wood | Shear Strength |
| | N/cm | N/cm | 250 g |
| EX1 | 27.8 | 13.7 | PASS, >72 |
| | | | hours |
| CE1 | 34.5 | 5.3 | PASS, >72 |
| | | | hours |

### Screw Fabrication:

A 25.4 cm (10.0 inch) head screw 154 with a diameter of 1.91 cm (0.75 inches) as represented in FIG. 4 was machined in a computer numerical controlled (CNC) three-axis vertical endmill. The machining process was performed on a solid block of aluminum using two operations. In the first step, the top half of the screw, as viewed down the screw axis, was machined. The partially milled block was flipped over, and the other half of the screw was then machined.

### Barrel Fabrication:

A 22.9 cm (9.0 inch) by 5.08 cm (2.0 inch) by 5.08 cm (2.0 inch) barrel 152 as represented in FIG. 2 was machined in a CNC three-axis vertical endmill. The machining process was performed on a solid block of aluminum. The center cavity was first drilled with a drill bit, and then reamed to 1.92 cm (0.7574 inches). A beveled inlet 174 was initially milled perpendicular to the barrel axis, and then a second milling operation was performed at an angle of 28 degrees offset from the parallel of the barrel axis.

### Robot Mounting Bracket Fabrication:

A robot mounting bracket with a thickness of 1.27 cm (0.5 inch) was machined out of aluminum. The robot mounting bracket featured tapped holes for mounting the alignment wheel motor. Two sets of through holes were placed to connect to the gearbox 156 mounting bracket and barrel mounting bracket. In addition, holes and a circular indention were provided for mounting to a UR-10 robot arm from Braas Corp. of Eden Prairie, Minn., United States.

### Gearbox Mounting Bracket Fabrication:

A gearbox 156 mounting bracket with a thickness of 1.27 cm (0.5 inch) was machined out of aluminum. The gearbox 156 mounting bracket featured holes for connecting to the face of a gearbox.

### Barrel Mounting Bracket Fabrication:

A barrel 152 mounting bracket with a thickness of 1.27 cm (0.50 inch) was machined out of aluminum. The barrel 152 mounting bracket featured holes for connecting to the face of the gearbox 156.

### Dispensing Nozzle Fabrication:

A dispensing nozzle 172 was machined with a threaded end. The threaded end had a 0.64-cm (0.25-inch) hole that connected to a 0.1-cm (3.94E-2 inch) by 1.27-cm (0.5-inch) slot opening.

### Alignment Wheel Fabrication:

A 2.54-cm (1.00-inch) thick alignment wheel 160 with a connected shaft was machined out of aluminum. The radius of curvature of the outside of the alignment wheel was 0.5 cm (0.196 inches).

### Alignment Wheel Heating Block Fabrication:

A 1.20-cm thick alignment wheel 160 heating block was machined out of aluminum. The block had two slots for mounting insertion heating cartridges obtained from McMaster-Carr of Elmhurst, Ill. United States.

### Thermal Shield Fabrication:

Four 0.16-cm thick thermal shields (left, right, top and bottom) were machined from glass-mica ceramic plates obtained from McMaster-Carr of Elmhurst, Ill. United States.

### Dispense Head Assembly:

An SVL-204 servo motor 158 obtained from Automation Direct of Cumming, Ga. United States was connected to a 10:1 gear box. The screw 154 was inserted into the barrel 152, and a thrust bearing, with washer on each side was put onto the screw shaft. Then, the barrel and screw assembly were inserted through the barrel 152 mounting bracket, with the thrust bearing and washers seating in the barrel mounting bracket. The gearbox 156 was mounted onto the gearbox bracket. The shaft of the gearbox 156 and the screw 154 were connected with a motor shaft coupler. Both the barrel 152 bracket and the gearbox 156 bracket were connected to the motor mounting bracket. The dispense head was mounted onto the robotic arm. The nozzle was screwed into the barrel. All electrical connections were made. The barrel was heated with three 100-Watt heating cartridges embedded within the barrel. The temperature was monitored with a type J thermocouple. The barrel was insulated with ceramic plates fastened to the exterior of the barrel.

All cited references, patents, and patent applications in the above application for letters patent are herein incorporated by reference in their entirety in a consistent manner.

In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A dispensing system comprising:
a dispensing head comprising:
a barrel including one or more heating elements;
an inlet extending through a side of the barrel for receiving the filament adhesive;
an outlet at a distal end of the barrel for dispensing the filament adhesive in molten form; and
a rotatable screw received in the barrel, the rotatable screw including at least one mixing element; and
a filament adhesive having a configuration to be received into the inlet of the dispensing head.

2. The dispensing system of claim 1, wherein the at least one mixing element comprises a plurality of posts disposed on a rotatable shaft.

3. The dispensing system of claim 1, wherein the filament adhesive comprises a core-sheath adhesive.

4. A dispensing system comprising:
a dispensing head comprising:
a barrel including one or more heating elements;
an inlet extending through a side of the barrel for receiving the filament adhesive;
an outlet at a distal end of the barrel for dispensing the filament adhesive in molten form; and
a rotatable screw received in the barrel; and
a filament adhesive having a configuration to be received into the inlet of the dispensing head, wherein the filament adhesive comprises a core-sheath adhesive.

5. The dispensing system of claim 3, wherein the core-sheath adhesive comprises a pressure-sensitive adhesive core that is viscoelastic at ambient temperature.

6. The dispensing system of claim 3, wherein the core-sheath adhesive comprises a sheath that is non-tacky at ambient temperature.

7. The dispensing system of claim 1, wherein the inlet comprises a beveled nip point defined in part by a front sidewall surface of the inlet that extends at an acute angle relative to a longitudinal axis of the rotatable screw.

8. The dispensing system of claim 7, wherein the acute angle is from 13 degrees to 53 degrees.

9. The dispensing system of claim 1, wherein the inlet extends along 10 percent to 40 percent of the nominal screw length of the rotatable screw.

10. The dispensing system of claim 1, wherein the rotatable screw further comprises a feed element adjacent to the inlet, the feed element comprising a plurality of gripping lugs.

11. The dispensing system of claim 1, wherein the rotatable screw has a length:diameter ratio of from 8:1 to 20:1.

12. The dispensing system of claim 1, further comprising a drive mechanism operatively coupled to the rotatable screw.

13. The dispensing system of claim 1, wherein the overall weight of the dispensing head is no more than 10 kg.

14. The dispensing system of claim 1, further comprising a spool from which the filament adhesive can be continuously unwound while it is being received into the inlet of the dispensing head.

15. The dispensing system of claim 14, wherein the spool is coupled to the dispensing head.

16. The dispensing system of claim 1, further comprising a movable arm, wherein the dispensing head is coupled to a distal end of the movable arm.

17. The dispensing system of claim 1, wherein the dispensing head is coupled to a table, and wherein either the dispensing head or the table is movable relative to the other.

18. The dispensing system of claim 17, further comprising a movable arm coupled to the table, wherein the dispensing head is coupled to a distal end of the movable arm.

19. The dispensing system of claim 17, wherein movement of the dispensing head or the table is controllable by a computer.

20. The dispensing system of claim 17, further comprising a spool from which the filament adhesive can be continuously unwound while it is being received into the inlet of the dispensing head, wherein the spool is mounted to the table or structure thereon.
